(19) United States
(12) Patent Application Publication
(10) Pub. No.: US 2013/0038264 A1
(43) Pub. Date: Feb. 14, 2013

(54) METHOD OF FAN SPEED CONTROL

(71) Applicants: Chien-Jung CHEN, Kaohsiung City (TW); Hsien-Wen LIU, Kaohsiung City (TW); Tzu-Wen TSAI, Kaohsiung City (TW)

(72) Inventors: Chien-Jung CHEN, Kaohsiung City (TW); Hsien-Wen LIU, Kaohsiung City (TW); Tzu-Wen TSAI, Kaohsiung City (TW)

(73) Assignee: YEN SUN TECHNOLOGY CORP., Kaohsiung City (TW)

(21) Appl. No.: 13/208,051

(22) Filed: Aug. 11, 2011

(51) Int. Cl. H02P 1/00

(52) U.S. Cl. 318/445

(57) ABSTRACT

In a method of fan speed control, a flow value corresponding to airflow amount through a fan during operation of the fan is detected with a fan controller. The flow value and a preset value are subsequently compared, and when the flow value is less than the preset value, a pulse-width-modulation (PWM) signal is outputted to increase rotation speed of the fan.

### BACKGROUND OF THE INVENTION

1. Field of the Invention

The invention relates to a method of control, more particularly to a method of fan speed control.

2. Description of the Related Art

In Taiwanese Patent Number I295421, entitled “Method for Automatically Controlling Rotation Speed of Fans”, there is disclosed a method which adjusts rotation speed of a fan according to a sensed temperature change of ambient surroundings, which is suitable in many applications.

Nevertheless, the rise in temperature may also be a result of other instances, such as a blockage of the inlet or the outlet of the fan or increased ambient drag. These instances can lower the airflow amount and subsequently, the heat-dissipating effect of the fan. Moreover, these instances are not reflected in the surrounding temperature immediately, and the method may thus not be able to detect and adjust rotation speed of the fan in time.

### SUMMARY OF THE INVENTION

Therefore, the object of the present invention is to provide a method of fan speed control that is able to maintain an optimal airflow amount/hydrostatic pressure value of the fan.

Accordingly, a method of fan speed control of the present invention includes:

a) detecting, with a fan controller, a flow value corresponding to airflow amount through a fan during operation of the fan;

b) comparing, with the fan controller, the flow value and a preset value; and

c) when the flow value is less than the preset value, outputting, with the fan controller, a pulse-width-modulation (PWM) signal to increase rotation speed of the fan.

### BRIEF DESCRIPTION OF THE DRAWINGS

Other features and advantages of the present invention will become apparent in the following detailed description of the preferred embodiment with reference to the accompanying drawings, of which:

FIG. 1 is a characteristic curve showing the airflow amount/hydrostatic pressure characteristic of a conventional fan;

FIG. 2 is a flow chart illustrating steps of a preferred embodiment of a method of fan speed control according to the invention;

FIG. 3 is a flow chart illustrating details of steps of the preferred embodiment; and

FIG. 4 is a plot showing the experimental results of the preferred embodiment.

### DETAILED DESCRIPTION OF THE PREFERRED EMBODIMENT

As shown in FIG. 2, the preferred embodiment of a method of fan speed control according to the present invention comprises steps 11˜14.

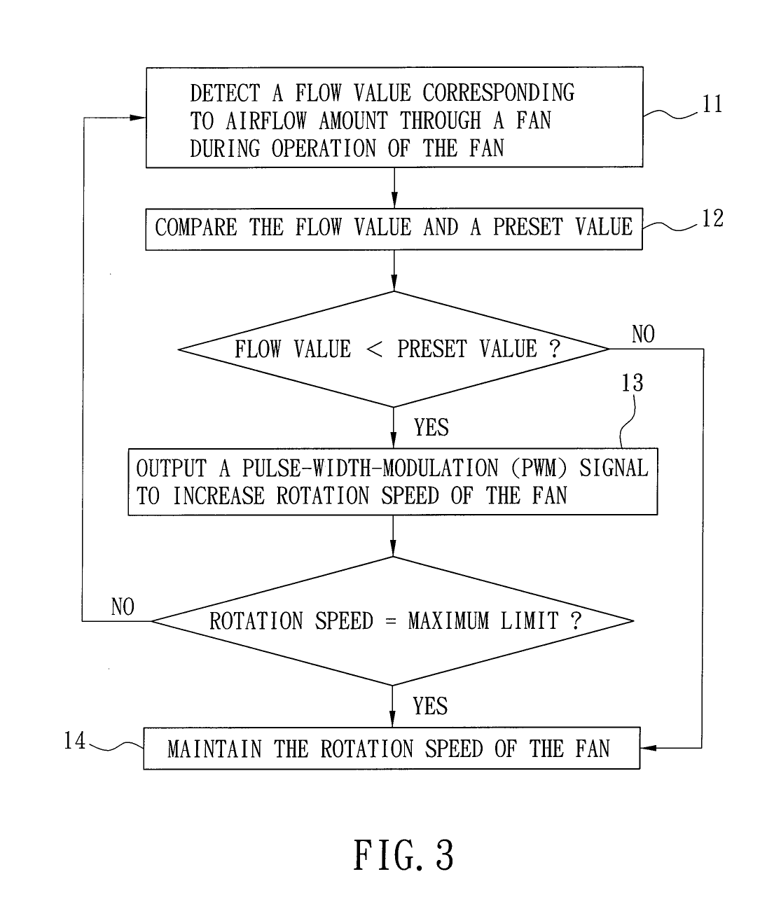

Further referring to FIG. 3, step 11 involves detecting a flow value corresponding to airflow amount through a fan during operation of the fan with a fan controller.

In this embodiment, the fan controller is configured to be a programmable micro controller unit (MCU), and the flow value is a fan current value detected during operation of the fan, which has a negative relation to extent of blocking experienced by the fan during operation of the fan. Alternatively, the fan controller can be an integrated circuit, and the flow value can be either a fan voltage value detected during operation of the fan, or a magnetic flux detected due to current flow through a fan coil during operation of the fan.

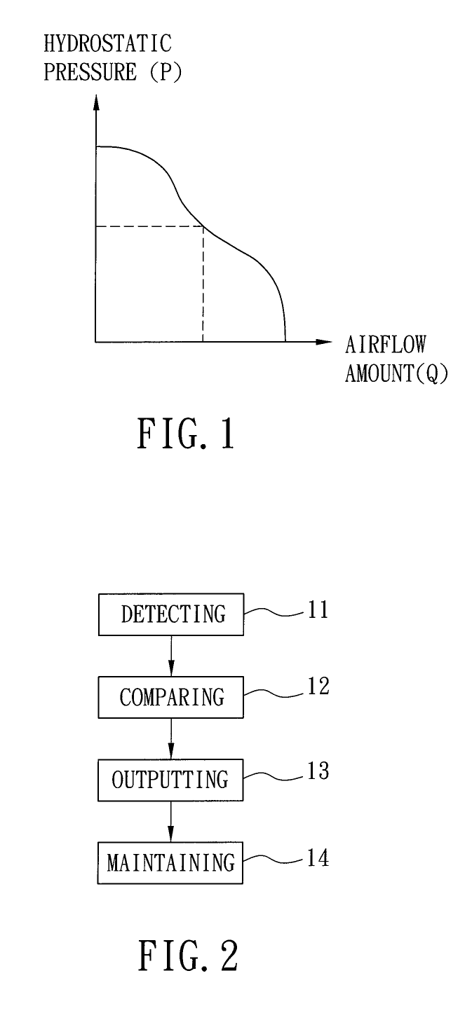

Step 12 involves comparing, with the fan controller, the flow value and a preset value. In this embodiment, the preset value is a fan current corresponding to an optimal airflow amount/hydrostatic pressure value obtained from a characteristic curve (see FIG. 1) of the fan.

Step 13 involves, when the flow value is less than the preset value, outputting, with the fan controller, a pulse-width-modulation (PWM) signal to increase rotation speed of the fan. Specifically, the outputted PWM signal is used to increase the rotation speed of the fan when the rotation speed of the fan has not reached a maximum limit, and is used to maintain the rotation speed of the fan at the maximum limit when the rotation speed of the fan has reached the maximum limit. In this embodiment, when it is determined in step 12 that the flow value is not less than the preset value, the rotation speed of the fan is maintained (i.e., the PWM signal is used to maintain the rotation speed of the fan).

Step 14 involves, when the flow value is not less than the preset value, maintaining the rotation speed of the fan. Since the flow value may vary after step 13 is executed, steps 11˜13, or alternatively steps 11˜14 are repeated for subsequent control of fan speed.

In order to verify the effect of the method, an airflow outlet of the fan was subjected to different extents of blocking, under such circumstances tests were conducted. Same results are expected when an airflow inlet of the fan is instead blocked.

It is worth noting that, the rotation speed of the fan, which is positively related to the flow value, was used in the experiments to represent the flow value for convenience.

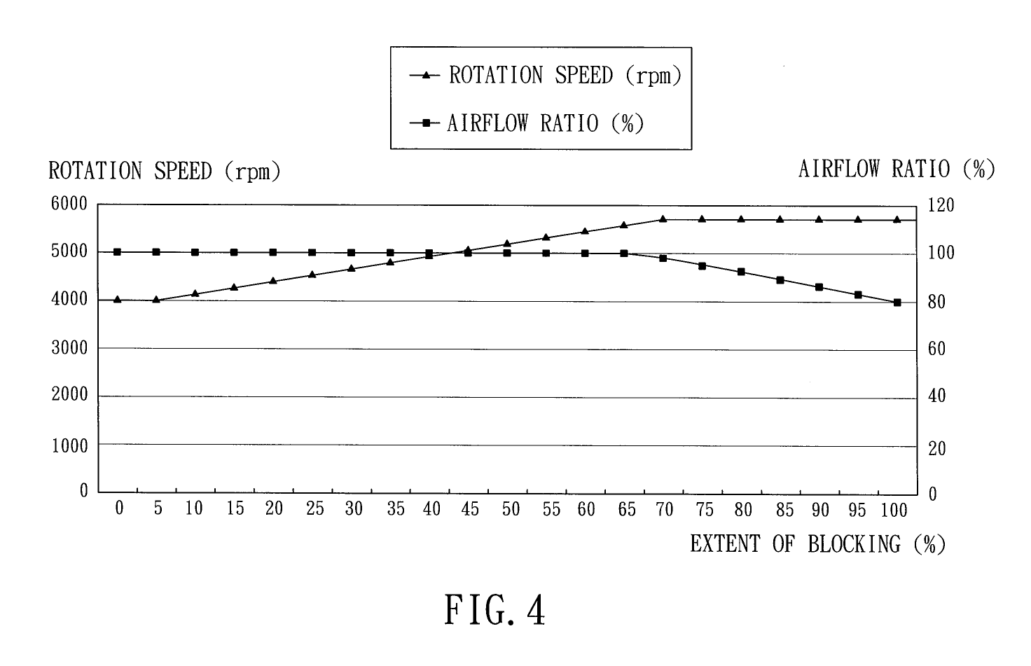

FIG. 4 shows rotation speed of the fan (left side of the vertical axis) and the extent of blocking of the airflow outlet of the fan (horizontal axis), versus an airflow ratio (right side of the vertical axis).

When the extent of blocking lies between 0˜5%, and the fan rotates at 4000 rpm, the airflow ratio is 100%, implying that the optimal airflow amount/hydrostatic pressure value is reached.

When 10˜65% of the airflow outlet is blocked, by outputting the corresponding PWM signals to control the fan to rotate at a speed ranging from 4100 rpm to 5500 rpm, the optimal airflow ratio can still be obtained.

At even higher blockages (70˜100%), the rotation speed of the fan is adjusted to the maximum limit (i.e., 5600 rpm in this case) and maintained. However the airflow ratio decreases as a larger portion of the airflow outlet is being blocked. The result indicates that a fan configured to have a maximum limit at 5600 rpm is not able to maintain the optimal airflow amount/hydrostatic pressure value when more then 70% of the airflow outlet (inlet) is blocked.

To sum up, the method of fan speed control of the present invention compares the flow value and the preset value, and adjusts the rotation speed of the fan accordingly. Whenever the fan experiences blocking or ambient drag is increased, such instances can be detected promptly, speeding up the rotation of the fan and so that the optimum airflow amount/hydrostatic pressure value may be maintained. The method assumes an efficient control over the fan, and fits in applications with the aforementioned instances, without having to include additional elements.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of fan speed control, comprising;
a) detecting, with a fan controller, a flow value corresponding to airflow amount through a fan during operation of the fan;
b) comparing, with the fan controller, the flow value and a preset value; and
c) when the flow value is less than the preset value, outputting, with the fan controller, a pulse-width-modulation (PWM) signal to increase rotation speed of the fan.

2. The method as claimed in claim 1, further comprising repeating steps a) to c).

3. The method as claimed in claim 1, further comprising:
d) when the flow value is not less than the preset value, maintaining the rotation speed of the fan.

4. The method as claimed in claim 3, further comprising repeating steps a) to d).

5. The method as claimed in claim 1, wherein, in step c), the outputted PWM signal is used to increase the rotation speed of the fan when the rotation speed of the fan has not reached a maximum limit, and is used to maintain the rotation speed of the fan at the maximum limit when the rotation speed of the fan has reached the maximum limit.

6. The method as claimed in claim 1, wherein the flow value is one of:
a fan current value detected during operation of the fan;
a fan voltage value detected during operation of the fan; and
a magnetic flux detected due to current flow through a fan coil during operation of the fan.

7. The method as claimed in claim 1, wherein the flow value is a fan current value detected during operation of the fan, and has a negative relation to extent of blocking experienced by the fan during operation of the fan.
